(19) United States
(12) Patent Application Publication
(10) Pub. No.: US 2026/0299630 A1
(43) Pub. Date: Oct. 1, 2026

(54) COOKING APPLIANCE AND KNOB ASSEMBLY THEREOF

(71) Applicant: Haier US Appliance Solutions, Inc., Wilmington, DE (US)

(72) Inventor: Paul Bryan Cadima, Crestwood, KY (US)

(21) Appl. No.: 19/092,003

(22) Filed: Mar. 27, 2025

(51) Int. Cl. G05G 1/08; G05G 5/00

(52) U.S. Cl. CPC G05G 1/082; G05G 5/005; G05G 2505/00

(57) ABSTRACT

A cooking appliance may include a control knob mounted to the cooking appliance. The control knob may include an adjustable body that may include a push body, a center projection defining a body opening, and a center cylinder positioned radially inward of the push body. The control knob may include a static body disposed within the body opening of the center projection. The control knob may include a support plate secured to the static body. The support plate may define a center hole coaxially aligned with a central axis. The control knob may include an external spring disposed around the center cylinder and positioned between the adjustable body and the support plate. The control knob may include a preload spacer movably positioned between the external spring and the support plate to adjust a preload of the external spring.

### FIELD OF THE DISCLOSURE

The present subject matter relates generally to a cooking appliance, and more particularly to a knob assembly for a cooking appliance.

### BACKGROUND OF THE DISCLOSURE

Knobs are commonly used on a variety of commercial and residential appliances to control an operating condition of the appliance. Knobs are particularly common on cooking appliances, such as stoves or cooktops. Various shapes and sizes can be used depending upon, for example, the intended application, aesthetics, and other factors.

For example, cooking appliances that include a cooktop traditionally have at least one heating element positioned on a panel proximate a cooktop surface for use in heating or cooking an object, such as a cooking utensil, and its contents. The heating element can operate to heat a cooking utensil directly through induction heating or can use another heat source such as electrically resistant coils or gas burners. Commonly, one knob corresponds to one or more heating elements such that rotation of the knob activates, ignites, or otherwise adjusts heat generated at the corresponding heating elements. In order to prevent accidental or inadvertent activation of the corresponding heating elements, many knobs require a compound movement (e.g., a push, a pinch, a squeeze, or the like in combination with a rotation of the knob) to activate or ignite the heating elements from rest (e.g., a state in which no heat is being generated at the heating elements or no fuel is being flowed to the same). For example, a valve or switch box to which the knob is connected can require the knob to be pushed inward before the knob can be rotated (e.g., to adjust the volume of fuel flowed to the heating element or otherwise alter the heat generated at the heating elements).

Certain drawbacks exist with these existing constructions, however. For example, such constructions often require pinching or squeezing efforts from a user before the knob can be rotated. Users having physical limitations, such as decreased hand dexterity, can have difficulties performing these efforts. As another example, existing constructions can still be susceptible to accidental activation that can occur, for instance, when a user leans on the knob and subsequently moves such that the knob is rotated.

Accordingly, a knob assembly that obviates one or more of the above-mentioned drawbacks would be beneficial.

### BRIEF DESCRIPTION OF THE DISCLOSURE

Aspects and advantages of the invention will be set forth in part in the following description, or may be obvious from the description, or may be learned through practice of the invention.

In one exemplary aspect of the present disclosure, a cooking appliance is provided. The cooking appliance may include a cooktop. The cooking appliance may include a heating element mounted to the cooktop. The cooking appliance may include a surface panel mounted to the cooktop forward from the heating element. The surface panel may include a forward face and a rearward face. The surface panel may define a central axis extending from the rearward face to the forward face. The cooking appliance may include a control knob mounted to the cooking appliance at the surface panel. The control knob may include an adjustable body. The adjustable body may include a push body, a center projection defining a body opening, and a center cylinder positioned radially inward of the push body. The control knob may include a static body disposed within the body opening of the center projection. At least a portion of the static body may be positioned in front of the center cylinder. The control knob may include a support plate secured to the static body. The support plate may define a center hole coaxially aligned with the central axis. The control knob may include an external spring disposed around the center cylinder and positioned between the adjustable body and the support plate. The adjustable body may be in forward-biased mechanical communication with the external spring. The control knob may include a preload spacer movably positioned between the external spring and the support plate to adjust a preload of the external spring.

In another exemplary aspect of the present disclosure, a knob assembly for a cooking appliance is provided. The knob assembly may define a central axis. The knob assembly may include a control knob mountable to the cooking appliance about the central axis. The control knob may include an adjustable body. The adjustable body may include a push body and a center projection defining a body opening. The control knob may include a static body disposed within the body opening. The control knob may include a support plate secured to the static body. The support plate may define a center hole coaxially aligned with the central axis. The control knob may include an external spring disposed between the support plate and the adjustable body. The adjustable body may be in forward-biased mechanical communication with the external spring. The control knob may include a preload spacer insertable between the external spring and the support plate. The external spring may define a first discrete preload setting when the preload spacer is inserted between the external spring and the support plate. The external spring may define a second discrete preload setting when the preload spacer is removed from between the external spring and the support plate.

In yet another exemplary aspect of the present disclosure, a knob assembly for a cooking appliance is provided. The knob assembly may include a control knob mountable to the cooking appliance. The control knob may include an adjustable body. The adjustably body may include a push body, a center projection defining a body opening, and a center cylinder positioned radially inward of the push body. The control knob may include a static body disposed within the body opening. The control knob may include a support plate secured to the static body. The support plate may include a cam projection extended from a front face of the support plate. The cam projection may include a first cam surface at a distal end of the cam projection. The control knob may include an external spring disposed between the support plate and the adjustable body. The adjustable body may be in forward-biased mechanical communication with the external spring. The control knob may include a preload spacer disposed around the center cylinder and positioned between the external spring and the support plate. The preload spacer may include a second cam surface engaged with the first cam surface.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a cooking appliance according to one or more exemplary aspects of the present subject matter.

FIG. 2 provides a perspective view of a control knob according to one or more exemplary aspects of the present subject matter.

FIG. 3 provides a cross-sectional view of a control knob mounted to a knob switch according to one or more exemplary aspects of the present subject matter.

FIG. 4 provides an exploded view of a control knob according to one or more exemplary aspects of the present subject matter.

FIG. 5 provides an exploded view of a control knob according to one or more exemplary aspects of the present subject matter.

FIG. 6 provides a sectional perspective view of a control knob assembly mounted to a control knob according to one or more exemplary aspects of the present subject matter, wherein the control knob is in a static state.

FIG. 7 provides a sectional perspective view of a control knob assembly mounted to a control knob according to one or more exemplary aspects of the present subject matter, wherein the control knob is in an adjustable state.

FIG. 8 provides a rear perspective view of a control knob according to one or more exemplary aspects of the present subject matter, wherein the control knob is at a minimum preload setting.

FIG. 9 provides a rear perspective view of a control knob according to one or more exemplary aspects of the present subject matter, wherein the control knob is at a maximum preload setting.

FIG. 10 provides an exploded view of a control knob according to one or more exemplary aspects of the present subject matter.

FIG. 11 provides an exploded view of support plate and a preload spacer of a control knob according to one or more exemplary aspects of the present subject matter.

FIG. 12 provides a rear perspective view of a portion of a control knob according to one or more exemplary aspects of the present subject matter.

FIG. 13 provides a side view of a control knob according to one or more exemplary aspects of the present subject matter, wherein the control knob is at a minimum preload setting.

FIG. 14 provides a side view of a control knob according to one or more exemplary aspects of the present subject matter, wherein the control knob is at a maximum preload setting.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a 10 percent margin (i.e., including values within ten percent greater or less than the stated value). In this regard, for example, when used in the context of an angle or direction, such terms include within ten degrees greater or less than the stated angle or direction (e.g., “generally vertical” includes forming an angle of up to ten degrees in any direction, such as, clockwise or counterclockwise, with the vertical direction V).

The word “exemplary” is used herein to mean “serving as an example, instance, or illustration.” In addition, reference to “an embodiment” or “one embodiment” does not necessarily refer to the same embodiment, although it may. Any implementation described herein as “exemplary” or “an embodiment” is not necessarily to be construed as preferred or advantageous over other implementations.

Except as explicitly indicated otherwise, recitation of a singular processing element (e.g., “a controller,” “a processor,” “a microprocessor,” etc.) is understood to include more than one processing element. In other words, “a processing element” is generally understood as “one or more processing element.” Furthermore, barring a specific statement to the contrary, any steps or functions recited as being performed by “the processing element” or “said processing element” are generally understood to be capable of being performed by “any one of the one or more processing elements.” Thus, a first step or function performed by “the processing element” may be performed by “any one of the one or more processing elements,” and a second step or function performed by “the processing element” may be performed by “any one of the one or more processing elements and not necessarily by the same one of the one or more processing elements by which the first step or function is performed.” Moreover, it is understood that recitation of “the processing element” or “said processing element” performing a plurality of steps or functions does not require that at least one discrete processing element be capable of performing each one of the plurality of steps or functions.

Embodiments of the present disclosure provide a knob assembly having one or more features for adjusting a preload setting of the knob assembly. Notably, the control knob of the exemplary knob assembly includes a preload spacer that may be movably positioned between an external spring and a support plate of the control knob. The preload spacer is configured for compressing or “preloading” the external spring to adjust a preload setting of the external spring. Notably, the preload spacer permits a preload setting (e.g., a setting of the control knob corresponding to a push force necessary to operate the control knob) to be selectively adjusted. In this regard, the control knob advantageously can include multiple preload settings that correspond to multiple push forces required to depress the control knob (e.g., compared to existing control knobs for cooking appliances that a non-adjustable discrete push force required to depress the control knob).

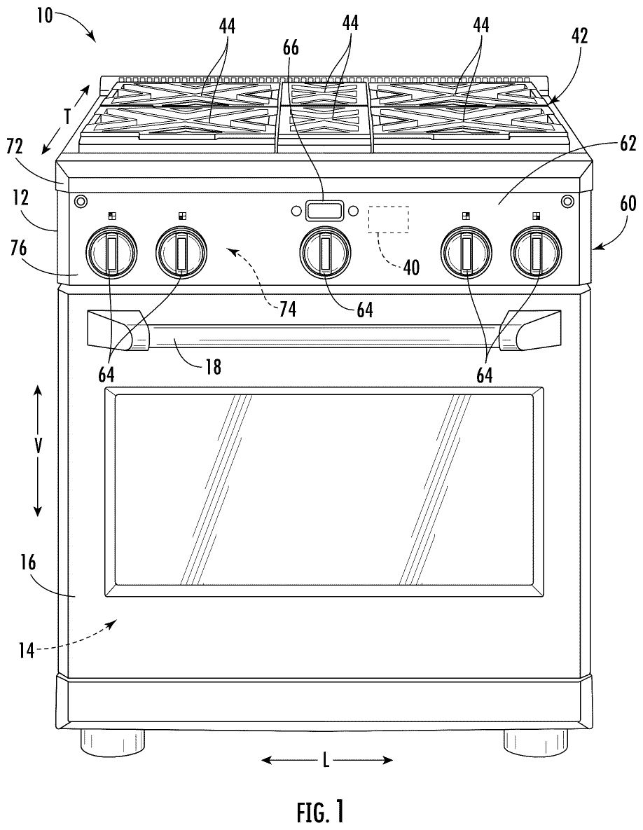

Turning now to the figures, FIG. 1 provides a perspective view of a cooking appliance, such as an oven appliance 10, according to exemplary embodiments of the present disclosure. Generally, oven appliance 10 defines a vertical direction V, a lateral direction L, and a transverse direction T. The vertical direction V, lateral direction L, and transverse direction T are mutually perpendicular and form an orthogonal direction system. As will be understood, oven appliance 10 is provided by way of example only, and the present subject matter may be used in any suitable appliance. Thus, the present disclosure may be used with other oven, range, or cooktop appliance configurations (e.g., configurations that define multiple interior cavities for the receipt of food, include no interior cavities, or are otherwise different than the configuration shown in FIG. 1), as well as other suitable appliances, as would be understood in light of the present disclosure.

Oven appliance 10 includes an insulated cabinet 12 with an interior cooking chamber 14 defined by an interior surface of cabinet 12. Cooking chamber 14 is configured for the receipt of one or more food items to be cooked. Oven appliance 10 includes a door 16 rotatably mounted to cabinet 12 (e.g., with a hinge—not shown). A handle 18 may be mounted to door 16 and may assist a user with opening and closing door 16 in order to access an opening to cooking chamber 14. For example, a user can pull on handle 18 to open or close door 16 and access cooking chamber 14 through the opening. As would be understood, one or more internal heating elements (e.g., baking or broiling heating elements) may be provided within cooking chamber 14 to cook or otherwise heat items therein.

Oven appliance 10 may include a seal between door 16 and cabinet 12 that assist with maintaining heat and cooking fumes within cooking chamber 14 when door 16 is closed, as shown in FIG. 1. One or more parallel glass panes 22 provide for viewing the contents of cooking chamber 14 when door 16 is closed and assist with insulating cooking chamber 14. Optionally, a baking rack may be positioned in cooking chamber 14 for the receipt of food items or utensils containing food items.

In some embodiments, oven appliance 10 includes a cooktop surface 42 having one or more heating elements 44 for use in heating or cooking operations. In exemplary embodiments, cooktop surface 42 includes a metal (e.g., steel) panel on which one or more grates may be supported. In other embodiments, however, cooktop surface 42 includes another suitable material, such as a ceramic glass or another suitable non-metallic material. Heating elements 44 may be various sizes, as shown in FIG. 1, and may employ any suitable method for heating or cooking an object, such as a cooking utensil (e.g., a pot, pan, or the like), and its contents. In one embodiment, for example, heating element uses a heat transfer method, such as electric coils or gas burners, to heat the cooking utensil. In another embodiment, however, heating element 44 uses an induction heating method to heat the cooking utensil directly. In turn, heating element may include a burner element, electric heat element, induction element, or another suitable heating element.

Some embodiments of oven appliance 10 include a controller 40 (e.g., configured to control one or more operations of oven appliance 10). For example, controller 40 may control at least one operation of oven appliance 10 that includes an internal heating element or cooktop heating element 44. Controller 40 may be in communication (via for example a suitable wired or wireless connection) with one or more of heating element(s) 44 and other suitable components of oven appliance 10, as discussed herein. In general, controller 40 may be operable to configure oven appliance 10 (and various components thereof) for cooking. Such configuration may be based, for instance, on a plurality of cooking factors of a selected operating cycle or mode.

By way of example, controller 40 may include one or more memory devices and one or more microprocessors, such as general or special purpose microprocessors operable to execute programming instructions or micro-control code associated with an operating cycle. The memory may represent random access memory such as DRAM, or read only memory such as ROM or FLASH. In one embodiment, the processor executes programming instructions stored in memory. The memory may be a separate component from the processor or may be included onboard within the processor.

Controller 40 may be positioned in a variety of locations throughout oven appliance 10. As illustrated, controller 40 may be located within a user interface 62 of oven appliance 10. In some such embodiments, input/output (“I/O”) signals may be routed between controller 40 and various operational components of oven appliance 10, such as heating element(s) 44, control knobs 64, display component 66, sensors, alarms, or other components as may be provided. For instance, signals may be directed along one or more wiring harnesses that may be routed through cabinet 12. In some embodiments, controller 40 is in communication with user interface assembly 62 and control knobs 64 through which a user may select various operational features and modes and monitor progress of oven appliance 10. In one embodiment, user interface assembly 62 may represent a general purpose I/O (“GPIO”) device or functional block. In one embodiment, user interface assembly 62 may include input components, such as one or more of a variety of electrical, mechanical, or electro-mechanical input devices including rotary dials, push buttons, and touch pads. User interface assembly 62 may include a display component 66, such as a digital or analog display configured to provide operational feedback to a user.

During use of oven appliance 10, the amount of heat delivered by each heating element 44 on cooktop 42 may be controlled by controller 40 and a corresponding knob assembly 60, described in detail below. For instance, knob assembly 60 may include one or more control knobs 64 mounted (e.g., rotatably) on a surface panel 76 of user interface 62 forward from heating elements 44 (e.g., along or relative to the transverse direction T). Each control knob 64 may correspond to a discrete heating element 44.

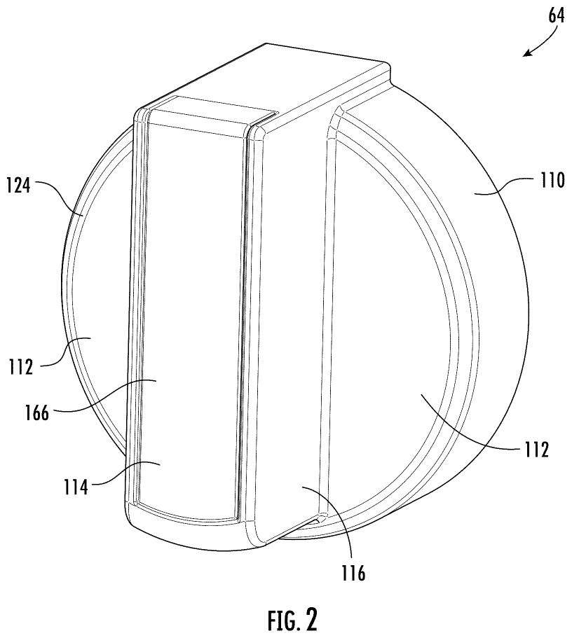

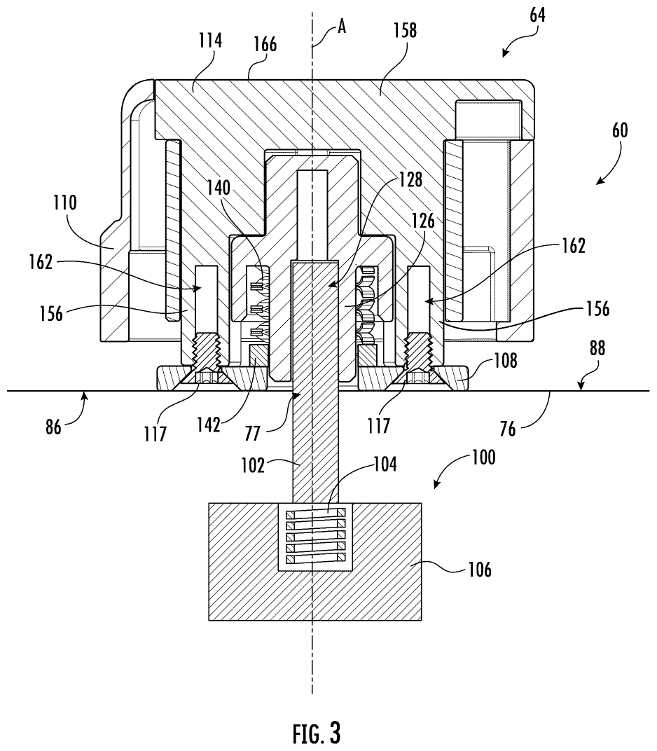

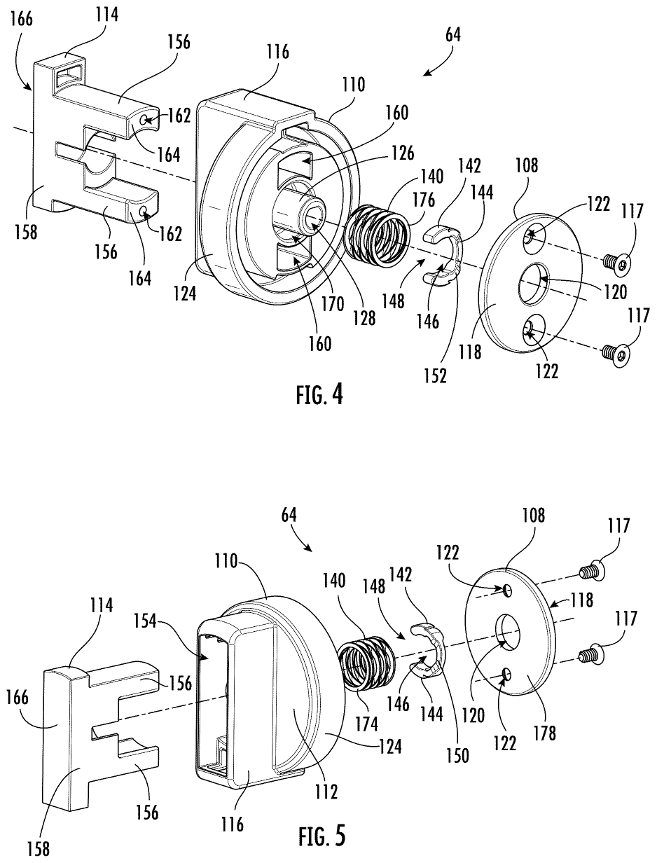

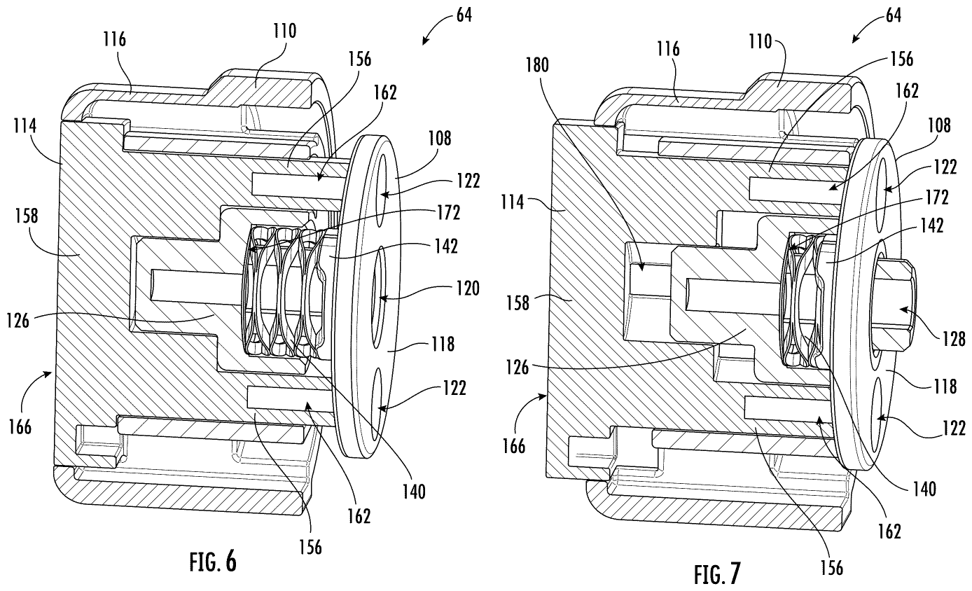

Turning now to FIGS. 2 through 7, various views are provided of a particular knob assembly 60 (e.g., including one control knob 64) and portions thereof, such as might be provided at a particular knob assembly 60 in FIG. 1. FIG. 2 provides a perspective view of the control knob 64 of the knob assembly 60. FIG. 3 provides a cross-sectional view of the knob assembly 64. FIGS. 4 and 5 provide exploded perspective views of the control knob 64. FIGS. 6 and 7 provide sectional views of control knob 64 in the static state and the adjustable state, respectively.

The knob assembly 60 may include a knob switch 100 and the control knob 64, which are connected to each other and mounted at surface panel 76. In some embodiments, surface panel 76 defines one or more axes or openings to permit mechanical or electrical connections between portions of knob assembly 60 or controller 40 (e.g., within cabinet 12). For instance, surface panel 76 may define a central axis A through an opening 77 extending from a rearward face 86 to a forward face 88 of surface panel 76 (e.g., perpendicular to the surface panel 76 or vertical direction V). Knob switch 100 may be disposed behind surface panel 76 while control knob 64 is disposed in front of surface panel 76.

The knob switch 100 may be provided as any suitable mechanism or device configured for detecting, or communicating a signal relating to, the rotational position of the control knob 64. For example, the knob switch 100 may include or be provided as a potentiometer, a digital encoder, or the like. In some exemplary embodiments, the knob switch 100 includes a suitable mechanical valve or electrical switch in communication with a slidable stem 102 and an internal spring 104 of knob switch 100. The slidable stem 102 may be extended from a switch body 106 (e.g., through surface panel 76) to form part of a suitable input mechanism for controlling a valve position or detecting and communicating a signal relating to the rotational position of control knob 64. The internal spring 104 may bias slidable stem 102 forward. During use, rotation of control knob 64 and the slidable stem 102 about the central axis A may alternately increase or decrease a voltage signal and, in turn, alternately increase or decrease an output of a heating element (e.g., heating element 44), as would be understood. Moreover, as would further be understood, internal spring 104 may be in forward-biased mechanical communication with the slidable stem 102 to require rearward translation of slidable stem 102 to permit subsequent rotation. Thus, after initially pushing slidable stem 102 rearward, slidable stem 102 may be permitted to rotate freely (e.g., within a predefined angle or circumferential path).

In some embodiments, control knob 64 includes various components that are generally mounted along and about a portion of central axis A (e.g., to direct the rotational position of slidable stem 102). Specifically, control knob 64 may include a support plate 108 that is rotatably mounted about the slidable stem 102 in front of the forward face 88. An adjustable body 110 having or defining push surfaces 112 may be rotationally fixed to the support plate 108 (e.g., while being slidable relative to the same). A static body 114 may be disposed within a central projection 116 of the adjustable body 110.

The support plate 108 may be held in place or otherwise secured to the control knob 64 via one or more mechanical fasteners 117, such as screws, bolts, or the like. For instance, the support plate 108 may be directly secured to the static body 114 and indirectly (e.g., via the static body 114) secured to the adjustable body 110. When assembled, support plate 108 may be permitted to rotate relative to surface panel 76 while being axially static. In other words, support plate 108 may function to rotate about the central axis A, but maintain a constant axial position relative to the central axis A. In some such embodiments, support plate 108 includes a contact surface 118 disposed on or against forward face 88 about a center hole 120 that is coaxial with central axis A. One or more fastener holes 122 may be defined through the contact surface 118 to permit the mechanical fasteners 117 to each extend therethrough.

In additional or alternative exemplary embodiments, one or more components of the control knob 64 may include integrated fastening means, such as snaps, tabs, or the like that are configured for further securing or coupling the one or more components of the control knob 64.

The adjustable body 110 may generally be disposed in front of support plate 108. Specifically, the adjustable body 110 may be mounted to the slidable stem 102 to move therewith. Thus, the adjustable body 110 may be slidable relative to support plate 108. Moreover, the adjustable body 110 may be rotationally fixed to support plate 108 such that rotation of the adjustable body 110 and slidable stem 102 may also rotate support plate 108. For instance, the static body 114 extending through the adjustable body 110 may be rotated by the adjustable body 110 and thereby direct rotation of support plate 108 too.

The adjustable body 110 may include or define a push body 124. The push body 124 may include the push surfaces 112 that extend outward, for instance, radially outward, from the slidable stem 102. In particular, push surfaces 112 may be radially spaced apart or outward from slidable stem 102 to permit a user to push the adjustable body 110. A center cylinder 126 of adjustable body 110, which is disposed radially inward from the push body 124, may bridge the radial space between slidable stem 102 and push body 124 (e.g., behind the central projection 116). In certain embodiments, center cylinder 126 extends across the central axis A. Moreover, the center cylinder 126 may provide an attachment surface or structure to connect the adjustable body 110 to the slidable stem 102. For instance, center cylinder 126 may define a slot 128 that is matched to the slidable stem 102. In other words, the shape of slot 128 may form the negative of the profile shape (e.g., a circular or non-circular profile shape) of the slidable stem 102 such that the slot 128 can receive the slidable stem 102 and be rotated by the same.

When assembled, the adjustable body 110 may be biased forward from or at a point apart from slidable stem 102. For instance, an external spring 140 may be disposed around the center cylinder 126 and positioned between the support plate 108 and the adjustable body 110. Specifically, the adjustable body 110 may be in forward-biased mechanical communication with external spring 140. The external spring 140 may be “external” in that it may be positioned outside or forward of the cooktop 42. As shown, the external spring 140 may be formed or provided as a coiled compression spring (e.g., to bias the adjustable body 110 forward relative to support plate 108). Nonetheless, any suitable spring structure (e.g., leaf spring, sponge spring, torsion spring, etc.) may be provided between the support plate 108 and the adjustable body 110. In turn, external spring 140 may further bias adjustable body 110 toward a static state (e.g., FIGS. 2, 3, and 6), even after a user has axially depressed adjustable body 110 to a rearward adjustable state (e.g., FIG. 7) wherein adjustable body 110 and slidable stem 102 may be rotated. Since slidable stem 102 is generally fixed relative to the adjustable body 110, axial movement of the adjustable body 110 between the static and adjustable states may similarly move slidable stem 102 (e.g., relative to surface panel 76 or a portion of the knob switch 100, which houses internal spring 104 and a valve or electronic switch, as is understood).

A preload spacer 142 may be movably positioned between the external spring 140 and the support plate 108, for instance, to adjust a preload setting of the control knob 64. As used herein “preload setting” of the control knob 64 may refer to an amount of compression or “preload” that the external spring 140 experiences in the static state of the control knob 64. For example, the preload spacer 142 may be insertable into a position between the external spring 140 and the support plate 108 or, conversely, removably from the position between the external spring 140 and the support plate 108. When the preload spacer 142 is inserted between the external spring 140 and the support plate 108, the preload spacer 142 may compress the external spring 140 in the static state of the control knob 64.

In some embodiments, the preload setting includes a first discrete preload setting and a second discrete preload setting. The first discrete preload setting may correspond to a preload of the external spring 140 when the preload spacer 142 is inserted between the external spring 140 and the support plate 108. For example, when the preload spacer 142 is inserted between the external spring 140 and the support plate 108 the external spring 140 may be compressed a distance substantially equivalent to the axial length of the preload spacer 142. The second discrete preload setting may correspond to a preload of the external spring 140 when the preload spacer 142 is not inserted (e.g., when the preload spacer 142 is removed) between the external spring 140 and the support plate 108. For example, when the preload spacer 142 is removed, the external spring 140 may not be preloaded or compressed.

The first discrete preload setting may correspond to a first push force required to depress or move the control knob 64 from the static state to the adjustable state. The second discrete preload setting may correspond to a second push force required to depress or move the control knob 64 from the static state to the adjustable state. The first push force may be greater than the second push force. For example, the first push force may be at least three times greater than the second push force. For example, the first push force may be approximately three to six pounds of force that a user may be required to apply to the adjustable body 110 and the second push force may be approximately one to two pounds that a user may be required to apply to the adjustable body 110. In this regard, when the preload spacer 142 is removed between the external spring 140 and the support plate 108, a push force required to depress or move the adjustable body 110 from the static state to the adjustable state may be lowered (e.g., relative to a push force required when the preload spacer 142 is inserted between the external spring 140 and the support plate 108). Notably, the adjustability of a preload setting of the external spring 140 advantageously increases a user experience. For example, a user that may desire a lowered push force (e.g., users having decreased hand dexterity) may selectively remove the preload spacer 142 from its position between the external spring 140 and the support plate 108. Conversely, a user that may desire a greater push force may selectively insert the preload spacer 142 into its position between the external spring 140 and the support plate 108.

The preload spacer 142 may include a ring body 144 that is positionable around the center cylinder 126. The ring body 144 may define an aperture 146 that is coaxially aligned with the central axis A and the center hole 120 of the support plate 108. In some embodiments, the preload spacer 142 is selectively snapped onto to the center cylinder 126 to adjust to preload setting of the external spring 140. In such embodiments, the ring body 144 defines a snap cut-out 148 through the ring body 144. The snap cut-out 148 may permit the ring body 144 to selectively engage with the center cylinder 126. Moreover, in such embodiments, the ring body 144 is formed from a resilient material that is configured to bend and deform slightly to engage with the center cylinder 126. For example, the ring body 144 may be formed from any suitable resilient materials such as polypropylene, nylon, polycarbonate, acrylonitrile butadiene styrene, or the like. Notably, a user may advantageously be permitted to selectively adjust the preload setting (e.g., by inserting or removing the preload spacer 142) of the external spring 140 without having to fully disassemble the control knob 64. When the preload spacer 142 is inserted between the external spring 140 and the support plate 108, a spring surface 150 of the preload spacer 142 may be directly engaged with the external spring 140 and a support surface 152 of the preload spacer 142 may be directly engaged with the support plate 108. When the preload spacer 142 is removed from between the external spring 140 and the support plate 108, the external spring 140 may be directly engaged with the support plate 108.

Separate from adjustable body 110, the static body 114 may be included with knob assembly 60. Specifically, the static body 114 may be disposed within a body opening 154 defined by the central projection 116 of the adjustable body 110, for instance, inward of the push body 124. The static body 114 may include a plurality of mount feet 156 that extend from a head portion 158 of the static body 114 toward the surface panel 76. The plurality of mount feet 156 may each be extended through the body opening 154 and feet apertures 160 defined through the push body 124 such that fastener holes 162 defined through rear surfaces 164 of the plurality of mount feet 156 may align with the fastener holes 122 defined through the support plate 108. In this regard, mechanical fasteners 117 may be extended through the fastener holes 122 and the fastener holes 162 to secure the static body 114 (e.g., directly) and the adjustable body 110 (e.g., indirectly via the static body 114) to the support plate 108.

The static body 114 may be an axially static member that is not permitted to slide with slidable stem 102 relative to surface panel 76. Additionally or alternatively, the static body 114 may define a stop surface 166 that may be disposed flush with or forward from adjustable body 110 (e.g., the entirety of the adjustable body 110 depending on the state of the adjustable body 110). As shown in FIGS. 2, 3, and 6, stop surface 166 may be positioned flush to proud with the central projection 116 of the adjustable body 110 when the adjustable body 110 is in the static state. In particular, the stop surface 166 may be positioned in line with or slightly forward of the distal or forward most edge of the central projection 116 of the adjustable body 110 when the adjustable body 110 is in the static state. As shown in FIG. 7, stop surface 166 may be forward of the central projection 116 (e.g., a distal or forward most edge of the central projection 116) of the adjustable body 110 when the adjustable body 110 is in the adjustable state.

In certain embodiments, at least a portion of the external spring 140 is positioned around the center cylinder 126. For instance, the push body 124 may define a spring opening 170 around the center cylinder 126. At least a portion of the external spring 140 may be disposed within the spring opening 170 and around the center cylinder 126 and engaged with a spring surface 172 disposed within the spring opening 170. The spring surface 172 may be positioned behind or rearward of the stop surface 166, for instance, such that it is positioned within the body opening 154. In this regard, a front side or edge 174 of the external spring 140 may interface or engage with the spring surface 172 of the center cylinder 126 and a rear side or edge 176 of the external spring 140 may interface or engage with the spring surface 150 of the preload spacer 142 (e.g., when the preload spacer 142 is inserted) or a front face 178 of the support plate 108 (e.g., when the preload spacer 142 is removed).

In certain embodiments, at least a portion of the static body 114 is disposed in front of the center cylinder 126 even while being at least a portion of the static body 114 radially bounded by at least a portion of the central projection 116. For instance, the static body 114 may define a rear recess 180 within which the center cylinder 126 is selectively received (e.g., as adjustable body 110 slides forward and rearward towards the static state and the adjustable state, respectively).

During use, a user may activate or ignite a heating element, such as a particular heating element 44 from a rest state by pushing against the push surfaces 112 of a corresponding control knob 64 to move the adjustable body 110 from the static state toward the adjustable state. As the adjustable body 110 is pushed rearward, slidable stem 102 may also slide rearward into the switch body 106 of knob switch 100, thereby compressing internal spring 104 and external spring 140. As shown, the static body 114 and the outer skirt 130 may each remain axially static even as the adjustable body 110 moves rearward to the adjustable state. In the adjustable state, the adjustable body 110 and slidable stem 102 may be permitted to rotate to activate, ignite, or otherwise vary heat generated at the corresponding heating element. Once a user has completed adjustment of the heat (e.g., moved the control knob 64 to a desired setting or rotational position), the user may release the adjustable body 110, thereby allowing external spring 140 to motivate the adjustable body 110 forward (e.g., back towards the static state). In the desired setting or rotational position, the slidable stem 102 may not snap out of the locked position until the control knob 64 is returned to a rest state that corresponds to an OFF position of the particular heating element. Thus, other than in the OFF position, the slidable stem 102 may stay depressed to continue to allow rotation without pushing of the adjustable body 110.

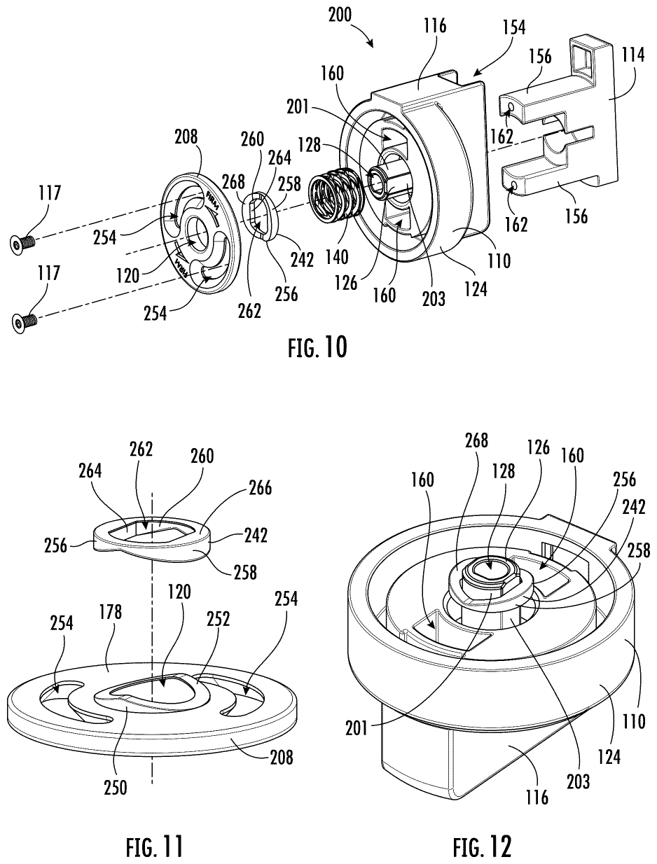

Referring now to FIGS. 8 through 14 various views of a control knob 200 in accordance with another exemplary aspect of the present disclosure is provided. The exemplary control knob 200 may be configured in substantially the same manner as the exemplary control knob 64 of FIGS. 1 through 7, and accordingly, the same or similar numbers may refer to the same or similar parts.

For example, the exemplary control knob 200 of FIGS. 8 through 14 generally includes an adjustable body 110, a static body 114, and an external spring 140. The adjustable body 110 may include a central projection 116 and a push body 124. The central projection 116 may define a body opening 154 for receiving the static body 114. The adjustable body 110 may define feet apertures 160 for receiving a plurality of mount feet 156 of the static body 114 therethrough. The adjustable body 110 may include a center cylinder 126 disposed radially inward from the push body 124. The center cylinder 126 may define a slot 128 for receiving a slidable stem of a knob assembly (e.g., slidable stem 102 of knob assembly 100).

However, for the embodiments, of FIGS. 8 through 14, the center cylinder 126 forms a non-circular profile shape (e.g., a non-circular cross-section). In such embodiments, the center cylinder 126 includes an outer wall 201 that defines the non-circular profile shape. For instance, the outer wall 201 may include one or more indexed portions 203 (e.g., flat portions) that extend along or parallel to the central axis A. Moreover, the center cylinder 126 may provide an attachment surface or structure to connect the adjustable body 110 to the slidable stem 102. For instance, the center cylinder 126 may define a slot 128 that is matched to the slidable stem 102. In other words, the shape of slot 128 may form the negative of the profile shape (e.g., a circular or non-circular profile shape) of the slidable stem 102 such that the slot 128 can receive the slidable stem 102 and be rotated by the same.

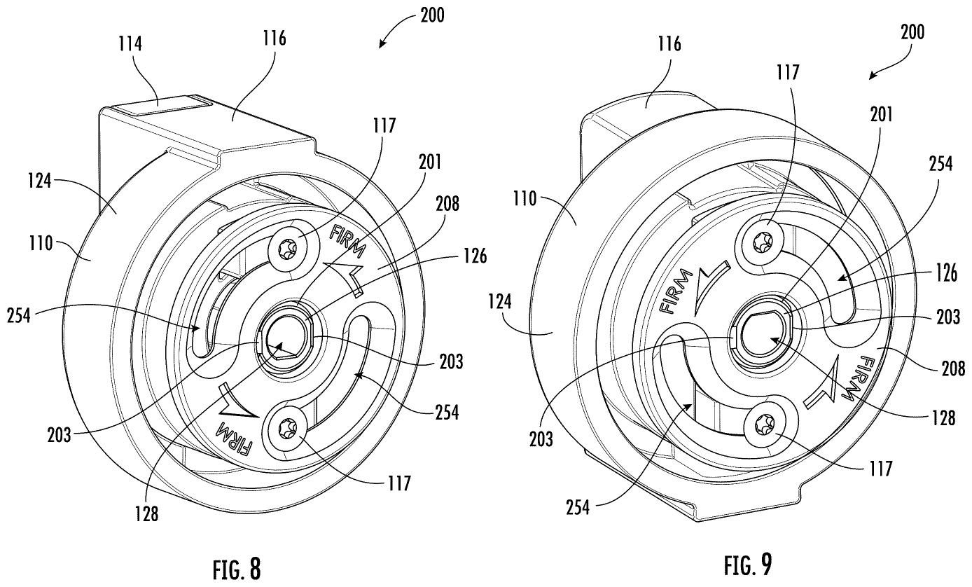

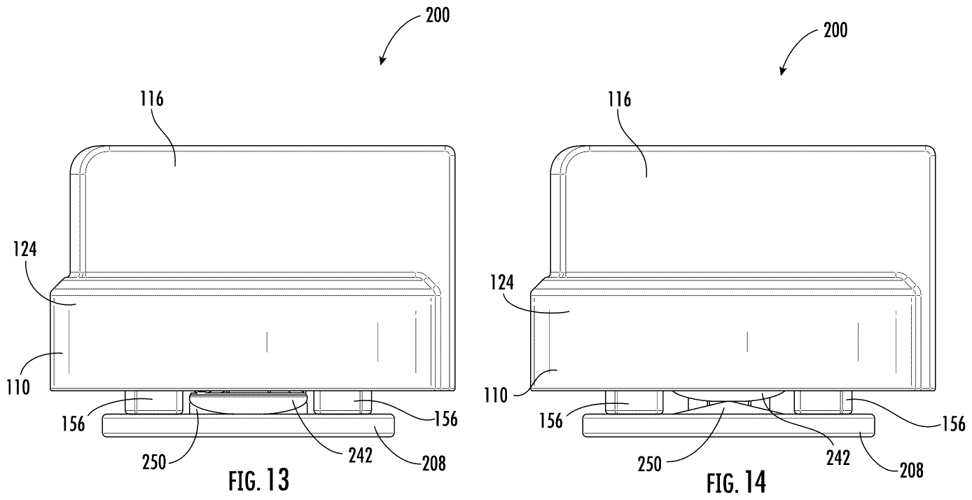

In addition, for the embodiments of FIGS. 8 through 14, the control knob 200 includes a support plate 208 and a preload spacer 242. The support plate 208 may be configured for adjusting a preload setting the external spring 140, and thus, a push force required to move the control knob 64 from the static state to the adjustable state. In particular, the support plate 208 may be selectively rotatable between a minimum preload position (e.g., FIGS. 8 and 13) and a maximum preload position (e.g., FIGS. 9 and 14) relative to the static body 114 or the adjustable body 110 to selectively adjust a preload setting of the control knob 64. In the minimum preload position of the support plate 208, the control knob 64 may define a minimum preload setting. In the maximum preload position of the support plate 208, the control knob 64 may define a maximum preload setting. The preload setting of the control knob 64 may correspond to an amount of push force required to depress the control knob from the static state to the adjustable state. For example, the maximum preload setting may require a greater push force to depress the control knob 64 than the minimum preload setting.

The support plate 208 may include a cam projection 250 extended from a front face 178 of the support plate 208. The support plate 208 and the cam projection 250 may together define the center hole 120. The cam projection 250 may include a first cam surface 252 at a distal end of the cam projection 250. As will be appreciated in more detail below, the first cam surface 252 may be engaged with a complementary cam surface (e.g., a second cam surface 268 described in more detail below) to translate rotation of the support plate 208 to axial movement of the preload spacer 242, and in turn, a preload (e.g., compression) of the external spring 140.

In addition, the support plate 208 may define a plurality of tracks 254 through the support plate 208 for selective receipt of mechanical fasteners 117. The plurality of tracks 254 may be positioned radially outward of the center hole 120 for the receipt of mechanical fasteners 117. In some embodiments, the plurality of tracks 254 are arcuate (e.g., curved or arched) shaped tracks that may define the minimum preload position (e.g., as shown in FIG. 8) and the maximum preload position (e.g., as shown in FIG. 9) for the control knob 64. After being rotated to the desired preload position (e.g., the minimum preload position, the maximum preload position, or an intermediate preload position at any suitable location along the plurality of tracks 254 between the minimum preload position and the maximum preload position), the support plate 108 may be held in place or otherwise secured to the control knob 64 via the mechanical fasteners 117. In particular, the mechanical fasteners 117 may lock or hold the support plate 208 in the desired preload position. The mechanical fasteners 117 may include or be provided as any suitable fastener that may secure or fasten the support plate 208 to the control knob 64. For example, the mechanical fasteners 117 may include screws, bolts, or any other suitable fastener that may be secure the support plate 208 and may be selectively removed to adjust a preload position of the support plate 208.

The support plate 208 may be directly secured to the static body 114 and indirectly (e.g., via the static body 114) secured to the adjustable body 110 via the mechanical fasteners 117. When assembled and secured in the desired preload position, the support plate 208 may be secured directly to the static body 114 and indirectly to the adjustable body 110 such that the support plate 108 may rotate with the adjustable body 110 and the static body 114 (e.g., when the adjustable body 110 is in the adjustable state) while remaining axially static relative to the surface panel 76.

The preload spacer 242 may be movable, for instance, axially about the central axis A, relative to the adjustable body 110. The preload spacer 242 may be disposed around the center cylinder 126 and positioned between the external spring 140 and the support plate 208. The preload spacer 242 may include a ring body 256. The ring body 256 may include an outer wall 258 and an inner wall 260 positioned radially inward of the outer wall 258. The inner wall 260 may define an aperture 262 for receiving the center cylinder 126 therethrough. As mentioned above, in some embodiments, the center cylinder 126 defines a non-circular profile shape. For example, the center cylinder 126 may include the outer wall 201 that includes the one or more indexed portions 203. In this regard, the outer wall 201 of the center cylinder 126 may define the non-circular profile shape. In some embodiments, the inner wall 260 of the ring body 256 is complementary in shape to the non-circular profile shape of the outer wall 201 of the center cylinder 126. For instance, the inner wall 260 may include one or more complementary indexed portions 264 that are matched to the one or more indexed portions 203 of the center cylinder 126. Notably, the inner wall 260 of the preload spacer 242 may be matched to the outer wall 201 of the center cylinder 126, such that the indexed portions 203 and the complementary indexed portions 264 prevent rotation of the preload spacer 242 relative to the center cylinder 126.

The ring body 256 may also include a spring surface 266 and a second cam surface 268, for instance, spaced apart along the central axis A. The spring surface 266 may be positioned forward of the second cam surface 268 and may be engaged (e.g., directly engaged) with the external spring 140. The second cam surface 268 may be engaged with the first cam surface 252 of the cam projection 250. In particular, the second cam surface 268 may be complementary to the first cam surface 252 such that rotational movement of the first cam surface 252 (e.g., caused by selectively rotating the support plate 208 between the minimum preload position and the maximum preload position) may result in axial movement of the preload spacer 242. In this regard, as the support plate 208 is rotated, the preload spacer 242 may move (e.g., forward or rearward) about the central axis A. As mentioned above, rotation of the preload spacer 242 (e.g., relative to the center cylinder 126) may be prevented due to the indexed portions 203 of the center cylinder 126 and the complementary indexed portions 264 of the preload spacer 136. In this regard, the preload spacer 242 may only move about the central axis A and rotational movement of the preload spacer 242 may be prevented or mitigated.

As an illustrative example, as the support plate 208 is rotated relative to the adjustable body 110, the first cam surface 252 may interact with the second cam surface 268 to move the preload spacer 242 (e.g., relative to the external spring 140). For instance, as the support plate 208 is rotated toward the maximum preload position, the first cam surface 252 may interact with the second cam surface 268 to move the preload spacer 242 (e.g., along a central axis A) toward the external spring 140, thus compressing the external spring 140. Conversely, as the support plate 208 is rotated toward the minimum preload position, the first cam surface 252 may interact with the second cam surface 268 to move the preload spacer 242 (e.g., along the central axis A) away from the external spring 140, thus decompressing the external spring 140. When the support plate 208 is positioned at a desired preload position (e.g., a position at or between the minimum preload position and the maximum preload position) the support plate 208 may be fastened to the static body 114 via the mechanical fasteners 117 to secure the support plate 208 to the static body 114 in the target preload position. As the preload setting of the control knob 64 may correspond to the preload position of the support plate 208, rotating the support plate 208 may selectively adjust a push force required to depress the control knob 64 from the static state to the adjustable state.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A cooking appliance comprising:
a cooktop;
a heating element mounted to the cooktop;
a surface panel mounted to the cooktop forward from the heating element, the surface panel comprising a forward face and a rearward face, the surface panel defining a central axis extending from the rearward face to the forward face; and
a control knob mounted to the cooking appliance at the surface panel, the control knob comprising:
an adjustable body comprising a push body, a center projection defining a body opening, and a center cylinder positioned radially inward of the push body;
a static body disposed within the body opening of the center projection, at least a portion of the static body being positioned in front of the center cylinder;
a support plate secured to the static body, the support plate defining a center hole coaxially aligned with the central axis;
an external spring disposed around the center cylinder and positioned between the adjustable body and the support plate, the adjustable body being in forward-biased mechanical communication with the external spring; and
a preload spacer movably positioned between the external spring and the support plate to adjust a preload of the external spring.

2. The cooking appliance of claim 1, wherein the preload spacer comprises a ring body defining an aperture coaxially aligned with the center hole of the support plate.

3. The cooking appliance of claim 1, wherein the preload spacer comprises a spring end directly engaged with the external spring and a support end directly engaged with the support plate.

4. A knob assembly for a cooking appliance, the knob assembly defining a central axis, the knob assembly comprising:
a control knob mountable to the cooking appliance about the central axis, the control knob comprising:
an adjustable body comprising push body and a center projection defining a body opening;
a static body disposed within the body opening;
a support plate secured to the static body, the support plate defining a center hole coaxially aligned with the central axis;
an external spring disposed between the support plate and the adjustable body, the adjustable body being in forward-biased mechanical communication with the external spring; and
a preload spacer insertable between the external spring and the support plate,
wherein the external spring defines a first discrete preload setting when the preload spacer is inserted between the external spring and the support plate, and
wherein the external spring defines a second discrete preload setting when the preload spacer is removed from between the external spring and the support plate.

5. The knob assembly of claim 4, wherein the first discrete preload setting corresponds to a first discrete push force,
wherein the second discrete preload setting corresponds to a second discrete push force, and
wherein the first discrete push force is greater than the second discrete push force.

6. The knob assembly of claim 4, wherein the preload spacer comprises a ring body defining an aperture coaxially aligned with the center hole of the support plate.

7. The knob assembly of claim 4, wherein ring body defines a snap cut-out through the ring body for inserting the preload spacer.

8. The knob assembly of claim 4, further comprising:
a knob switch engaged with the adjustable body, the knob switch comprising an internal spring and a slidable stem extending through a center hole of the support plate, the slidable stem being in forward-biased mechanical communication with the internal spring.

9. The knob assembly of claim 8, wherein the adjustable body comprises a center cylinder positioned radially inward from the push body and behind at least a portion of the static body, and
wherein the adjustable body is mounted to the slidable stem at the center cylinder.

10. The knob assembly of claim 9, wherein the center cylinder defines a slot matched to the slidable stem to be rotated thereby, and
wherein the slidable stem is received within the slot.

11. The knob assembly of claim 9, wherein the external spring and the preload spacer are each positioned around the center cylinder.

12. A knob assembly for a cooking appliance, the knob assembly comprising:
a control knob mountable to the cooking appliance, the control knob comprising:
an adjustable body comprising a push body, a center projection defining a body opening, and a center cylinder positioned radially inward of the push body;
a static body disposed within the body opening;
a support plate secured to the static body, the support plate comprising a cam projection extended from a front face of the support plate, the cam projection comprising a first cam surface at a distal end of the cam projection;
an external spring disposed between the support plate and the adjustable body, the adjustable body being in forward-biased mechanical communication with the external spring; and
a preload spacer disposed around the center cylinder and positioned between the external spring and the support plate, the preload spacer comprising a second cam surface engaged with the first cam surface.

13. The knob assembly of claim 12, wherein the support plate is selectively rotatable between a minimum preload position and a maximum preload position relative to the adjustable body.

14. The knob assembly of claim 12, wherein the preload spacer comprises a ring body defining an aperture coaxially aligned with a center hole of the support plate.

15. The knob assembly of claim 12, further comprising:
a knob switch engaged with the adjustable body, the knob switch comprising an internal spring and a slidable stem extending through a center hole of the support plate, the slidable stem being in forward-biased mechanical communication with the internal spring.

16. The knob assembly of claim 15, wherein the adjustable body comprises a center cylinder positioned radially inward from the push body and behind at least a portion of the static body, and
wherein the adjustable body is mounted to the slidable stem at the center projection.

17. The knob assembly of claim 16, wherein the center cylinder defines a slot matched to the slidable stem to be rotated thereby, and
wherein the slidable stem is received within the slot.

18. The knob assembly of claim 16, wherein the center cylinder comprises an outer wall defining a non-circular profile shape, and
wherein the preload spacer includes an inner wall defining a shape complementary to the outer wall.

19. The knob assembly of claim 12, wherein the static body comprises a head portion and a plurality of mount feet,
wherein the plurality of mount feet each extend from the head portion toward the support plate, and
wherein the plurality of mount feet are positioned within feet apertures defined through the push body.

20. The knob assembly of claim 19, wherein the support plate defines plurality of tracks through the support plate, and
wherein the plurality of mount feet are secured to the support plate via one or more mechanical fasteners disposed through the plurality of tracks.
